(19) United States
(12) Patent Application Publication
(10) Pub. No.: US 2026/0186613 A1
(43) Pub. Date: Jul. 2, 2026

(54) CONTEXTUAL CUEING FOR APPLICATIONS

(71) Applicant: GOOGLE LLC, Mountain View, CA (US)

(72) Inventors: Jesse Hong Lee, San Francisco, CA (US); Trevor Nicholas Perrier, Seattle, WA (US); Jeffrey Scott Cohen, San Francisco, CA (US); Alexander Thomas Castle, San Jose, CA (US); Juan Bernardo Mejia Reyes, Seattle, WA (US); Justin Robert DeWitt, Bainbridge Island, WA (US); Poojita Thukral, Palo Alto, CA (US); Zi Wang, Sunnyvale, CA (US); Rui Feng, Sunnyvale, CA (US); Janice An Lei Wong, San Francisco, CA (US); Dmitry Gennadievich Titov, Woodinville, WA (US); Megan Michaux Jablonski, Seattle, WA (US); Sergio Eduardo Collazos Iriarte, San Francisco, CA (US); Tarun Bansal, Bellevue, WA (US); Michael Blair Crouse, Seattle, WA (US); Sophie Chang, Seattle, WA (US)

(21) Appl. No.: 19/422,645

(22) Filed: Dec. 17, 2025

Related U.S. Application Data
(60) Provisional application No. 63/740,801, filed on Dec. 31, 2024.

(51) Int. Cl. G06F 3/0481; G06F 16/2457

(52) U.S. Cl. CPC G06F 3/0481; G06F 16/24578

(57) ABSTRACT

Techniques are directed to a solution to the problem of underutilization of features offered by an application such as a browser by making such features more visible to a user by automatically (i.e., without user intervention), surfacing a user interface element configured to invoke a feature selected from a set of available features of the application in response to determining that the feature is relevant to the content displayed by the application. In some implementations, the set of available features is derived from a prespecified association between one or more resource identifiers (e.g., web page uniform resource locators (URLs)) and at least one feature.

### CROSS REFERENCE TO RELATED APPLICATIONS

This application claims the benefit of U.S. Provisional Application No. 63/740,801, filed on Dec. 31, 2024, the disclosure of which is hereby incorporated by reference in its entirety

### BACKGROUND

Some applications have a large number of features that are designed to assist a user complete a task. The user may not be aware of one or more of the features because, for example, the one or more features were added in a recent version of an application.

### SUMMARY

The concepts discussed herein are directed to a technique for modifying a presentation of content in a user interface of an application to proactively suggest features of the application that are relevant to the content displayed in the user interface. For example, the application may include a browser for accessing resources from a network, e.g., the Internet. The technique involves selecting a feature of the application based on the content and displaying a user interface element associated with the feature (e.g., a part of the user interface that invokes the feature) on the display. In some implementations, the user interface element is displayed outside of the user interface. In some implementations, the feature is selected from an available set of browser features. In some implementations, the available set of features is based on the content and a user history. Once the user interface element is displayed, the user may interact with the user interface element to invoke a function of the feature. Proactively surfacing a feature of the application when that feature is relevant to the content being viewed by the user provides a better human-computer interface by enabling the user to use the application more optimally.

In a general aspect, a computer program product comprising a nontransitory storage medium, the computer program product including code that, when executed by processor, causes the processor to perform a method. The method can include presenting content in a user interface of an application on a display. The method can also include identifying a feature of the application based on the content. The method can further include, in response to identifying the feature, displaying an element of the user interface associated with the feature on the display.

In another general aspect, a method can include presenting content in a user interface of an application on a display. The method can also include identifying a feature of the application based on the content. The method can further include, in response to identifying the feature, displaying an element of the user interface associated with the feature on the display.

In another general aspect, an electronic apparatus can include memory and a processor coupled to the memory. The processor can be configured to present content in a user interface of an application on a display. The processor can also be configured to identify a feature of the application based on the content. The processor can further be configured to, in response to identifying the feature, display an element of the user interface associated with the feature on the display.

The details of one or more implementations are set forth in the accompanying drawings and the description below. Other features will be apparent from the description and drawings, and from the claims.

### BRIEF DESCRIPTION OF THE DRAWINGS

FIG. 1A is a diagram illustrating an example user interface element associated with a feature of the application for the case of the application including a browser according to the implementations described herein.

FIG. 1B is a diagram illustrating an example detail of the user interface element associated with the feature of the application.

FIG. 2 is a diagram illustrating an example electronic environment in which a modification of the presentation of the user interface with a user interface element may be implemented.

FIG. 3 is a flow chart illustrating an example process of identifying a feature of the application for display in a user interface.

FIG. 4 is a sequence diagram illustrating an example process of identifying a feature of the application for display in a user interface.

FIG. 5 is a diagram illustrating an example electronic environment in which the identification of the feature may be implemented.

FIG. 6 is a flow chart illustrating an example method of identifying a feature of the application for display in a user interface.

### DETAILED DESCRIPTION

The technology described herein enables an application, like a web browser, to proactively suggest useful features of the application at the right moment. Some applications have powerful tools that users often don't know about or forget how to use. This technology addresses this by analyzing the content a user is viewing—such as a webpage—and then displaying a small, non-intrusive prompt or button that suggests a relevant action. For example, if a user is reading a complex article about financial planning, a button might appear that says, “Ask a question about this page.” Clicking it could reveal pre-written questions like, “What's the difference between a Roth IRA and a 401(k)?” This helps users discover and use the full power of their application without having to search through menus.

In the case of a browser, the process of providing these smart suggestions begins when a user navigates to a webpage. A technical problem with conventional systems that use large language models (LLMs) to generate content-based suggestions is the significant computational cost and latency associated with invoking the model. Invoking an LLM for every webpage, regardless of its suitability, wastes processing cycles, network bandwidth, and energy, leading to an inefficient and slow user experience. The disclosed technology provides a technical solution to this problem by implementing a multi-stage eligibility verification process that filters out ineligible content before engaging the resource-intensive LLM. When a user lands on the webpage, the system first performs a lightweight, preliminary eligibility check. This check may occur on the client device or by sending a request containing only the page's URL to a metadata server (e.g., ZSS metadata server 203). This server returns a classification or an eligibility flag based on predefined policies, identifying pages that are ineligible for suggestions, such as those behind a paywall, containing sensitive political topics, or violating other content policies. By using this efficient, URL-based pre-screening, the system avoids the need to extract and process the full content of every page. Only if the content is deemed eligible by this initial check does the system proceed to gather key information such as the page's title and main text. This ordered, multi-layered approach provides a specific improvement to computer functionality by conserving computational resources and ensuring that the powerful but costly LLM is only invoked when necessary.

This information is then sent in a structured prompt to an artificial intelligence (AI) model on a remote server (e.g., context model server 207), which generates a few relevant, helpful suggestions tailored specifically to the page content. These suggestions are then sent back to the user's device and displayed on the screen. The AI model itself provides a second layer of defense, as it is configured with its own safety filters and can decline to generate suggestions if it determines the content is inappropriate, even if it passed the initial screening. This multi-layered approach to policy compliance provides a robust technical improvement that enhances the safety and reliability of the system.

Another technical problem in client-server systems that provide dynamic content is user-perceived latency. The time required to extract page context, establish a network connection, send a request to a server, and receive a response can result in a noticeable delay for the user. The disclosed technology provides a technical solution to this latency problem by proactively preparing for a suggestion request before the user explicitly initiates it. The system is configured to detect a user hover event—that is, when the user positions their cursor over the UI element associated with the feature (e.g., UI element 110) without clicking. The detection of this hover event acts as a trigger for the system to prepare for the user's interaction with the feature (e.g., establishing a socket for the chat), or determining if the initial extraction was lightweight (e.g., metadata only) and the hover triggers the heavy extraction (full inner text). Specifically, the system begins extracting the page context (URL, title, inner text) and initiates a pre-connection to the remote model server. By performing these steps proactively, the system ensures that when the user subsequently clicks the UI element, the page context is already available and the network connection is already warm. This significantly reduces the total time required to fetch and display the suggestions, resulting in a faster, more responsive, and improved human-computer interface.

Using the disclosed techniques in a financial example, a user may browse a web page that contains complex financial information, such as a comparison of different types of retirement accounts. The user may not know what specific questions to ask to understand the nuances of the topic. An application, such as a web browser, can analyze the content of the web page and proactively present a user interface element with suggested queries, such as “What are the key differences between these accounts?” or “Summarize the tax implications for each.” This allows the user to quickly gain a deeper understanding of the material without navigating away from the page or manually formulating complex search terms.

In another example, a user is shopping online for a consumer electronic device, such as a digital camera. The product page contains a long list of technical specifications that can be difficult to parse and compare against other models. The technology can recognize the context of the page and surface a feature that offers to summarize the specifications or compare the product to another model the user has recently viewed. This automates the cumbersome task of gathering and comparing information, helping the user make a more informed purchasing decision.

In another example, a student is conducting research using an online academic journal. The student is viewing a dense, multi-page article and needs to identify the core arguments and supporting evidence. The application can detect that the user is viewing a long-form document and offer contextual assistance. Suggested actions might include “Summarize the abstract of this paper,” “List the key findings,” or “Generate a list of related articles.” This transforms the application into a more powerful research tool, enhancing the user's productivity and comprehension.

As used herein, “content” refers to the information presented to a user within an application's user interface, particularly in the context of a web page or other network resource. This includes specific data elements such as the page title, its Uniform Resource Locator (URL), and the page's inner text or body. The definition can also be expanded to encompass “content metadata,” which includes characteristics produced from the page, such as file type or text length, as well as broader contextual data. For instance, in situations where the immediate page lacks sufficient information (e.g., a new tab page), “content” may also refer to a user's recent browsing history or a user-provided resource, such as a file or a tab explicitly added to an input area.

As used herein, “user interface” (UI) refers to a medium through which a user interacts with an application or electronic device. It encompasses the presentation of content on a display as well as the interactive elements that allow a user to control the application. These elements can include graphical components like windows, buttons, text boxes, and menus that a user manipulates with a keyboard, mouse, or touch input. The UI is responsible for surfacing an application's features, sometimes proactively displaying a “UI element” to suggest a relevant function based on the content being viewed. The overall design and layout, or “UI treatment,” aims to provide a better human-computer interface by making the application's functionality more visible, accessible, and efficient for the user to operate.

As used herein, “application” can refer to a software program—such as a browser-based application, internet browser, or operating system—that presents content to a user through a user interface. These software applications are equipped with features, which can be built-in or added as extensions, to enhance productivity, convenience, and the overall user experience by automating tasks or proactively suggesting relevant functions.

As used herein, a “feature” refers to a specific capability or function within an application, such as an internet browser, that is designed to increase productivity, convenience, and overall functionality. These features, which can be included with a release of the application or provided by a third party as an “extension,” enhance the user experience by performing tasks such as summarizing or synthesizing information, automating workflows, and saving time. Examples of features include conversational artificial intelligence (AI) agents that can answer questions about on-screen content, image-based search tools, and read-aloud modes. By proactively surfacing relevant features to a user, an application can be used more optimally, leading to a more efficient and helpful human-computer interface.

As used herein, “list of features” refers to a data structure containing one or more application features that have been determined to be available for potential presentation to a user. This list is dynamically generated or retrieved based on the current application context, such as the content of a webpage, and serves as the pool of candidates from which a specific feature is selected, for example, through a ranking process.

As used herein, “identifying” refers to the process of automatically (without user intervention/action) selecting a relevant application feature based on the content being presented to a user. This process may begin by determining if the content is eligible for feature identification, which can involve checking the content's resource locator (e.g., URL) or other characteristics against pre-defined policies to screen out ineligible content, such as pages with paywalls or sensitive topics. For eligible content, a feature may be identified by mapping the content's resource locator to a pre-specified list of features or by retrieving metadata that directly associates the content with a feature. Alternatively, identification may involve analyzing the content to extract signals (e.g., page title, URL, and inner text), which are then provided to a prediction engine or a large language model. This model then selects a feature by ranking available features based on their relevance to the analyzed content and, in some cases, a user's history, ultimately resulting in the selection of a top-ranked feature to be surfaced in the user interface.

As used herein, an “element” of a UI refers to a distinct component that represents and provides an entry point to a specific application feature. As described in the application, its primary purpose is to proactively surface or “nudge” a user toward a feature that is contextually relevant to the content being displayed, such as a web page. This element can take various forms, from a simple button to an expandable “floaty” that reveals a text input box and a list of suggested prompts. The visual presentation, or “UI treatment,” of the element can be dynamic, appearing more prominent for new users or employing visual emphasis to draw the user's attention, thereby making the application's features more discoverable and encouraging more optimal use of the application.

As used herein, a “resource” refers to any form of digital content that can be requested by a user device and received from a server over a network, such as the Internet. Typically accessed via an application like a browser, a resource is identified by a resource locator, such as a Uniform Resource Locator (URL). Resources encompass a wide variety of digital content, including web pages formatted in a markup language, word processing documents, Portable Document Format (PDF) documents, images, videos, and data feeds. The content of a resource can include text, images, multimedia, embedded information such as metadata, and/or embedded instructions such as scripts.

As used herein, a “browser” refers to an application used to access and display content from resources on a network, such as the Internet. While commonly referring to internet browsers, the term can broadly include any application that provides browser-like functions, such as navigating to web pages via URLs, managing content in tabs, and rendering information for a user. Modern browsers often act as personalized user agents, integrating advanced features like conversational AI that can leverage the context of a displayed page—including its content, title, and URL—to proactively provide relevant information or suggest actions, thereby enhancing the user experience.

As used herein, “ranking” refers to a computational process used to select the most relevant feature from an available set of application features to proactively present to a user. This selection is based on a calculated relevance score for each feature, which determines its position in an ordered list. The ranking is primarily based on the context of the content being displayed, such as the text, title, and URL of a webpage, and may also incorporate the user's browsing history with their permission. The underlying logic for determining these scores can be a set of predefined rules or a machine learning model, like a prediction engine. This process is often preceded by eligibility checks that filter out content based on established policies, such as pages containing sensitive topics or paywalls, effectively ensuring that only appropriate and useful features are ranked and ultimately surfaced.

As used herein, “relevance score” refers to a numerical value used to assess the relevance of a particular application feature to a user's current context, which is primarily defined by the content of a web page and, with user permission, the user's browsing history. The score is typically generated by a prediction engine or machine learning model that is trained to identify which features are most applicable to specific content. This model analyzes inputs such as the page's text, title, and URL, along with user history data, to rank a set of available features. The feature with the highest relevance score is then considered the most pertinent and is selected to be proactively surfaced to the user, thereby enhancing the application's utility and providing a more optimal user experience.

As defined herein, “relevance” refers to a measure of the utility and appropriateness of proactively suggesting an application feature based on the user's current context. This determination is multifaceted, derived from analyzing signals such as the content of a displayed web page (including its title, URL, and text), the application's own capabilities, and, with user permission, the user's recent browsing history. Relevance can be quantified as a score, calculated either through rule-based systems that map content characteristics to features or through machine learning models, such as a large language model prompted to generate questions a user would typically ask about the page. The concept also includes negative constraints, where a feature is deemed not relevant if the content is ineligible due to policy violations (e.g., sensitive topics, paywalls). By ranking features based on this comprehensive assessment of relevance, the system can surface the most helpful tools for the user's immediate task, thereby creating a more optimal and context-aware user experience.

As defined herein, “user history” refers to data pertaining to a user's past interactions with an application, such as a web browser. With user permission, this data can include browser history data, previous actions performed using the browser, expressed or inferred user preferences, and user interests. It may also encompass more immediate context, such as a user's recent browsing activity, to help inform what actions or suggestions might be most relevant. This historical and contextual information can be used by a prediction engine or relevance model to rank application features and personalize the user experience by surfacing the most useful tools for a given task.

As used herein, “resource locator” refers to an identifier used to locate a resource, such as a web page or document, on a network like the Internet. In the context of the application, a resource locator is typically a Uniform Resource Locator (URL), which serves as the unique address for content accessible via a browser. This URL, along with page title and content, is sent to a server to determine a page's eligibility for certain features and to generate contextual suggestions. For instance, a system can verify if a resource locator matches one in a pre-specified list to associate the corresponding web page with an available set of browser features.

As used herein, “characteristic of the content” refers to an attribute derived from an analysis of a resource such as a web page. These characteristics can include explicit metadata like the page's URL, title, and file type (e.g., whether it is a PDF), as well as implicit properties derived from the page's substance, such as the length of its text. Furthermore, a characteristic can be a classification of the content's topic or nature, such as whether it is educational, shopping-related, or contains sensitive material like heavy political commentary that would make it ineligible for certain features based on predefined policies. These characteristics are then used to determine the relevance of one or more application features to the content, which in turn informs the selection of a feature to surface to the user.

As used herein, “prediction engine” refers to a model or system configured to analyze a set of inputs to forecast an outcome or determine a course of action. In some implementations, a prediction engine uses a machine learning component, such as a neural network or a large language model, to process inputs and generate a predictive output. For example, in the context of surfacing relevant application features, a prediction engine can receive inputs that include the content of a web page (e.g., its URL, title, and inner text) and, with user permission, a user's browsing history. The engine processes these inputs to generate an output, such as a ranking of available features according to their relevance to the content and user context, or a set of contextual suggestions for user queries. The application can then use this output to proactively display the most relevant feature or prompt to the user.

As used herein, “classification” refers to a process of evaluating a resource, such as a web page, to determine its eligibility for surfacing one or more application features. This determination is based on a set of predefined policies that screen for certain characteristics, rendering some content ineligible. For instance, content may be classified as ineligible if it is behind a paywall, originates from a specific domain (e.g., a search engine results page), or contains sensitive subject matter such as heavy political commentary or violence. The outcome of this classification dictates whether a feature, such as the generation of contextual suggestions by a large language model, will be triggered. If the content is classified as eligible, a feature identification may be received, whereas an ineligible classification results in a null identification, preventing further processing and ensuring that features are only surfaced in appropriate and policy-compliant contexts.

As used herein, “feature identification” refers to a selection of a relevant application feature to proactively surface to a user based on the content they are currently viewing in the user interface. The process typically begins with an eligibility check to determine if the content, such as a webpage, is suitable for feature suggestions and complies with established policies, thereby filtering out sensitive, paywalled, or otherwise ineligible material. If the content is deemed eligible, a set of available features is determined by analyzing characteristics or “signals” from the content, such as its URL, title, and text. These features may then be ranked by a prediction engine or model that assesses their relevance to the content and, in some cases, the user's history, with the top-ranked feature ultimately being selected for presentation to the user.

As used herein, “null identification” refers to the outcome when the system determines that no application feature should be identified for the content being presented to a user. As detailed in the patent application, a null identification is received when the content is assigned a classification indicating its ineligibility for feature identification. This can occur for several reasons, as discussed in the transcript, such as when the content is deemed sensitive (e.g., containing political or violent material), is located behind a paywall, or otherwise violates system policies. This determination can be made through a multi-layered process that includes both preliminary checks on page metadata and a final assessment by a model that can refuse to generate suggestions. The result of a null identification is that no contextual feature is surfaced to the user; instead, the system may display generic suggestions or no suggestions at all.

As used herein, “hover event” refers to a type of user interaction detected when a user positions a cursor over a specific user interface element, such as an AI button, without clicking. Such an event may serve as a proactive trigger to reduce user-perceived latency. Upon detecting a hover, the system initiates preparatory background tasks, such as page context extraction (including the page's URL, title, and inner text) and preconnecting to a device such as a remote server configured to run a model that outputs a feature identification. This optimization ensures that when the user subsequently clicks the element to request suggestions, the necessary data and server connections are already established, enabling the system to fetch and display the contextual suggestions more efficiently.

Applications such as browser-based applications, like many applications, have features that increase their productivity and convenience. As used herein, a browser-based application includes any application that provides browser-like functions, including operating systems and Internet browsers. For convenience, browser-based applications are referred to as just browsers herein. Examples of features of a browser include an image-based search, a read-aloud mode, and AI agents, including conversational artificial intelligence (AI) agents. In some implementations, the features are included with a release of the browser. In some implementations, at least one feature is provided by a third party apart from the browser, e.g., provided as an “extension” to the application. Examples of tasks that can be accomplished by such features include “automatically summarizing, comparing, transforming, or synthesizing information,” “automating cumbersome workflows and routines,” and “saving time and getting things done faster.”

In some implementations, the browser uses content metadata to perform tasks such as those described above. Examples of content metadata include an indication of the web page that a user is currently accessing, information about a tab or tabs that are open in the browser, actions performed in a current web page, and, with user permission, browser history data, including previous actions that were performed using the browser, user preferences, and/or user interests.

A technical problem with applications such as browsers is that features such as those described above may not be visible to the user. Put another way, the existence of such features may not be known and/or the method of surfacing the features may not be readily apparent even if the feature is known. Accordingly, it may be difficult for users to discover new features or remember existing features because of the sheer number of such features and because new features are frequently added. Moreover, even if a user is aware of a feature, the user may not be aware of the particular context in which the feature may be best used. Such a lack of use of the features of the application makes the application less effective than intended and results in a less-than-optimal user experience.

Disclosed implementations provide a technical solution to the problem of underutilization of features offered by an application such as a browser by making such features more visible to a user by automatically (i.e., without user intervention), surfacing a user interface element configured to invoke a feature selected from a set of available features of the application in response to determining that the feature is relevant to the content displayed by the application. In some implementations, the set of available features is derived from a prespecified association between one or more resource identifiers (e.g., web page uniform resource locators (URLs)) and at least one feature. In some implementations, a feature is selected from the available set of features based on a ranking of the features. The ranking is based on relevance of the features to the content.

A technical advantage of the technical solution is that, by automatically surfacing the most relevant features of the application for content, the user is using the application more optimally and is having the better experience intended by developers of the application. Moreover, the technical solution implements a latency reduction technique wherein a hover event is used as a trigger for preparatory actions. Upon detecting that a user has positioned a cursor over the feature's user interface element, the system proactively initiates background tasks before the user clicks the element. These tasks include extracting page context—such as the page URL, title, and inner text—and establishing a pre-connection to the remote server responsible for generating suggestions. The technical benefit of this solution is a reduction in user-perceived latency, as the page context is already available and the network connection is warm when the user ultimately clicks the element to request suggestions, enabling a more efficient and faster response.

The “ranking” and “identification” processes described herein are not merely data organization but specific computational steps integrated into the browser's operation to optimize memory and display resources. For instance, by strictly limiting the number of displayed UI elements based on a dynamic ranking of relevance scores, the system prevents user interface clutter and reduces the rendering burden on the graphics processing unit (GPU). This selective rendering, driven by the specific rules of the prediction engine, ensures that the limited screen real estate of the display is utilized for the most high-value interactions, thereby improving the specific functioning of the graphical user interface system itself.

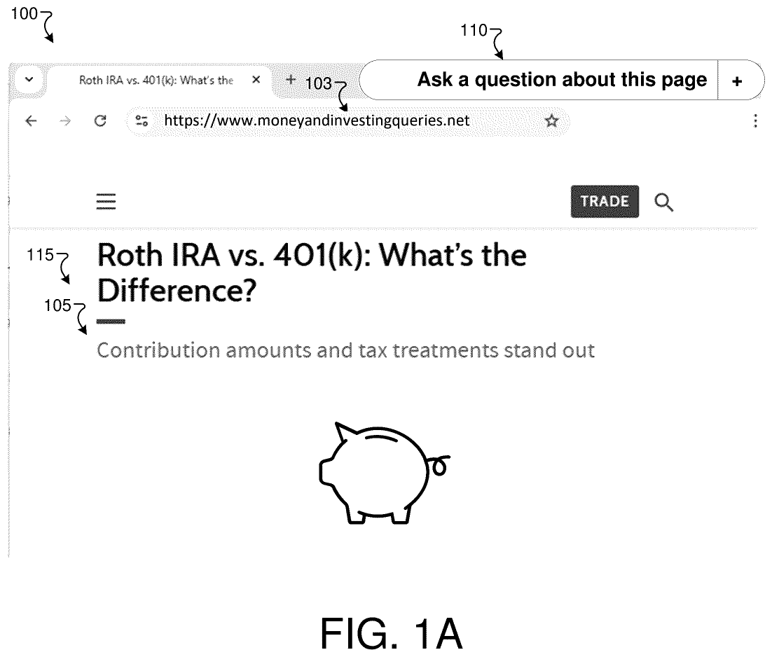

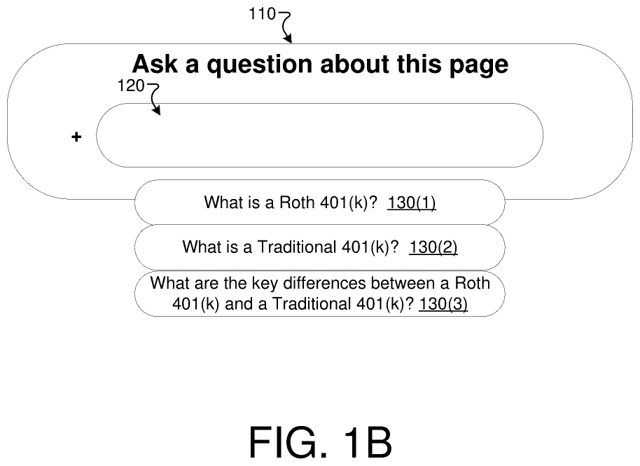

FIG. 1A is a diagram that illustrates an example user interface element 110 that proactively surfaces a feature of a browser window 100. This example is not intended to be limiting and is presented for ease of discussion. As shown in FIG. 1A, the browser window 100 presents content 105 of a web page associated with a uniform resource locator (URL) 103 in a main content area 115 of the browser window 100.

The browser has a set of features that enhance the functionality of the Internet browser and make the experience of using the browser more convenient, more efficient, more pleasurable, or some or all of these. Examples of features of a browser include an image-based search, a read-aloud mode, and a conversational artificial intelligence (AI). Such features can make the browser act as a more personalized and helpful user agent. Examples of tasks that can be accomplished by such features include “automatically summarizing, comparing, transforming, or synthesizing information,” “automating cumbersome workflows and routines,” and “saving time and getting things done faster.”

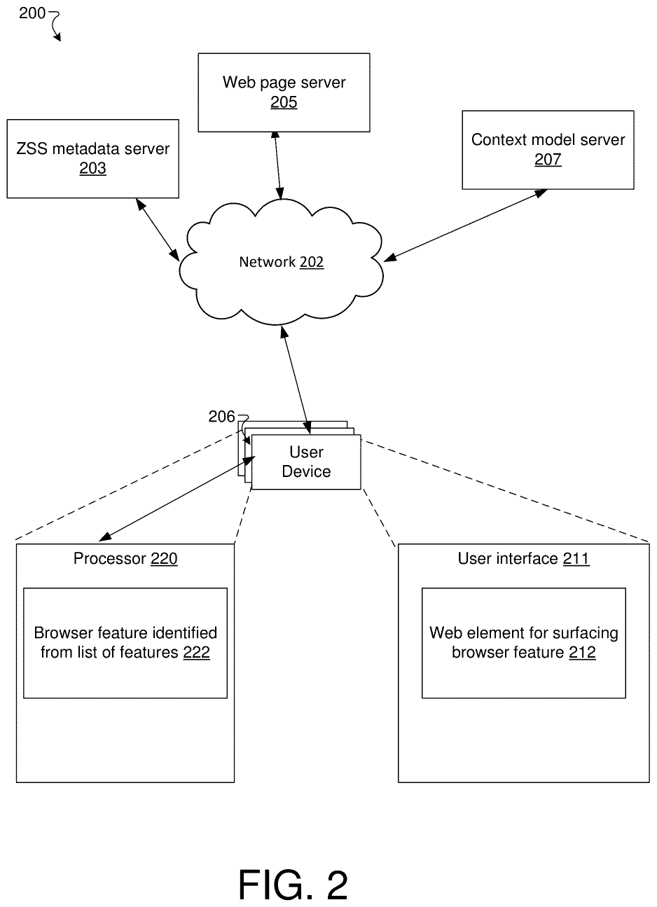

In response to the content 105 being presented in a browser window of the browser and displayed in a display, the browser, via processor 220 (FIG. 2), selects a feature of the browser to surface for the user. Once the feature is selected, a user interface (UI) element 110 associated with the feature is presented on the display. As shown in FIG. 1A, the UI element 110 is presented outside the main content area 115 but in the browser window 100. In some implementations, the UI element 110 may be presented in the main content area 115 of the browser.

As shown in FIG. 1A, an example UI element 110 is associated with a conversational AI feature. Such a feature is configured to provide answers to questions according to a generative model, such as a large language model (LLM) or small language model (SLM). As implemented in the Internet browser, the conversational AI feature is configured to provide the user with additional detail about the content 105 without leaving the web page, e.g., downloading another web page. Further details about the UI element 110 are discussed with regard to FIG. 1B.

FIG. 1B is a diagram illustrating an example detail of the UI element 110 associated with the feature of the Internet browser. As shown in FIG. 1B, the UI element 110 associated with the conversational AI feature is expanded to provide a text box 120 for asking a question about the web page, e.g., the content 105 in the main content area 115. The input to the text box 120 can be provided by a keyboard. In some implementations, the input to the text box 120 can be provided by speech from the user.

The input to the text box 120 can be a question about the web page. In some implementations and as shown in FIG. 1B, the UI element 110 can, via processor 220, provide sample questions 130(1), 130(2), 130(3) about the web page. Sample questions such as sample questions 130(1), 130(2), 130(3) are based on the content 105 of the web page and on content from other web pages across the Internet.

In response to the inputting of a question such as sample questions 130(1), 130(2), 130(3), the Internet browser, via processor 220, provides an answer to the question. The answer to the question is, in some implementations, based on content including content 105 and content from other web pages. The answer is, in some implementations, presented in a window within the UI of the Internet browser but outside of the browser window. In some implementations, the answer is presented in a window in the browser window alongside the content 105.

It is noted that the example illustrated in FIGS. 1A and 1B is not intended to be limiting and is presented for ease of discussion. For example, the example shown in FIGS. 1A and 1B with content 105 and the selected feature represented by UI element 110 covers but one feature of the Internet browser. Other features such as an image-based search and a read-aloud mode would have their own associated UI elements.

The UI element 110 represents a surfacing of a feature of the browser to the user to try the conversational AI feature of which the user may not have been aware. In some implementations, the UI element 110 has additional properties that draw the user's attention to the UI element 110. For example, the UI element 110 may blink, be bold, be of a certain color, or have any other emphasis.

In some implementations, the feature associated with the UI element 110 is selected from an available set of features of the browser. In some implementations, the selection of a feature of the browser is based on the content 105 of the web page. In some implementations, the selection of the feature is based on a ranking of the offset of available features of the browser. In such an implementation, the selected feature would be one of the top-ranked or the top-ranked feature. The ranking, in some implementations, is based on the relevance of a feature to the content 105 of the web page. In some implementations, and with user permission, the ranking is also based on the relevance of the feature of a list of features to a user history.

In some implementations, the relevance of the feature to content or to a user history is assessed via a relevance score. Such a relevance score may be based on a model, e.g., a machine learning model that is trained to identify which content is relevant to which feature of the set of available features of the browser. In some implementations, the machine learning model includes a neural network.

Although the above discussions and FIG. 1A discusses a single UI element associated with a single feature, in some implementations, there can be multiple UI elements, each associated with a respective feature of the Internet browser. In some implementations, the system may employ a hierarchy of visual treatments to manage user attention. For example, a highly relevant feature may be surfaced as a prominent “chip” containing text (e.g., “Ask a question”), while other relevant but lower-ranked features may be surfaced simultaneously as smaller, less obtrusive icons. To prevent user fatigue, the system may enforce frequency caps on the prominent chip treatment. For instance, the system may limit the display of suggestion chips to a specific number per session (e.g., five0 or a specific number per feature per session (e.g., three). Once a limit is reached, subsequent eligible features may be visually downgraded from a chip to an icon, ensuring functionality remains accessible without disrupting the user experience.

In some implementations, the offset of available features of the Internet browser derives from an association between the feature and a prespecified list of web page URLs. That is, the processor 220 in such implementations examines the URL of the web page with content 105 to see if there is a match of the URL with a URL included in the prespecified list of URLs. If there is a match, then the processor acquires the offset of available features from an entry in the table corresponding to the URL.

In some implementations, the set of available features of the browser derives from an analysis of the content 105 of the web page. For example, the analysis of the content 105 of the web page may result in a characteristic of the content 105. Such a characteristic may be termed a “signal.” For example, one such characteristic of the content 105 is the content length, e.g., a length of page content from inner text on the web page. Depending on content length, a feature or features of the Internet browser may be added to the list of features, e.g., conversational AI and read-aloud mode. Another example of a characteristic, or signal, is file type, e.g., whether the web page loads as a portable document format (PDF); in this case, if the document is not a PDF, then a feature or features of the Internet browser may be added to the list of features, e.g., conversational AI, read-aloud mode, and image-based search. In some implementations, a table is constructed to map the characteristic, or signal, of the content 105 to an available set of features of the Internet browser.

In some implementations, the ranking of the available set of features is performed via a set of rules based on the content 105. In some implementations, the set of rules is based on the characteristics of the content. In some implementations, the ranking of the set of available features is performed using a model. In some implementations, the model is a prediction engine. In some implementations, the prediction engine includes a machine learning component. In some implementations, the machine learning component includes a neural network. In some implmentations, the prediction engine is implemented on a remote server, or partially or entirely as an on-device component to reduce latency and preserve privacy. For example, the user device 206 may utilize a small language model (SLM) or a Bidirectional Encoder Representations from Transformers model stored locally in memory. This local model can process the extracted signals (e.g., DOM structure, text snippets) to generate classification scores or ranking outputs without transmitting the full page content to a remote server. This hybrid inference approach allows for rapid relevance assessment while reserving resource-intensive server calls for complex content generation. In some implementations, the prediction engine includes an on-device LLM (e.g., BERT) to assess feature relevance locally, reducing server costs and latency.

In some implementations, the process of surfacing a user interface element involves a mediation or arbitration step to resolve conflicts with other browser notifications. The browser may include legacy triggering systems (e.g., automatic translation prompts or price tracking alerts) that operate independently of the disclosed contextual cueing system. To prevent user interface clutter, the processor 220 may be configured with precedence rules. For example, if a high-priority legacy trigger (such as a translation prompt) is active for the current page, the system may suppress the display of the UI element 110 associated with the identified feature, or strictly relegate it to a less obtrusive visual treatment (e.g., an icon instead of a chip). This centralization of logic ensures that the user is not overwhelmed by multiple simultaneous suggestions from different subsystems of the application.

FIG. 2 is a diagram illustrating an example electronic environment 200 in which the modification of the presentation of the web page with a UI element (e.g., UI element 110) may be implemented. The example of a UI element associated with a conversational AI feature of the Internet browser has been discussed. Other example UI elements associated with other features of the Internet browser include read-aloud mode and image-based search. In short, any feature of an Internet browser may be associated with a UI element that can be presented in a display with a browser window of the Internet browser.

As shown in FIG. 2, the electronic environment 200 includes a user device 206 and a network 202 through which the user device accesses an Internet browser from a web page server 205, e.g., a browser application server. The network 202 may take the form of, e.g., a local area network (LAN), wide area network (WAN), the Internet, or a combination thereof. In some examples, the network 202 can be accessed over a wired and/or a wireless communications link. For example, mobile computing devices, such as smartphones can utilize a cellular network to access the network. There may be multiple user devices 206 and web page server 205 in the electronic environment 200.

In addition, the network 202 is, as shown in FIG. 2, connected to a zero state suggestion (ZSS) metadata server 203 and a context model server 207. The ZSS metadata server 203 is a backend component responsible for providing URL-keyed metadata to determine if a web page is eligible for zero-state suggestions. The ZSS metadata server 203 receives a request from the user device 206, such as a page navigation or user hover event. In response, the ZSS metadata server 203 provides a classification that can take the form of an eligibility flag or, for some static pages, a list of pre-computed contextual suggestions. If pre-computed suggestions are unavailable but the page is deemed eligible, the ZSS metadata server 203 coordinates with other backend systems, such as a context model server, to generate dynamic suggestions based on the page's content before returning the final suggestions to the client. Put another way, the ZSS metadata server 203 is configured to provide a classification of the content of the application, e.g., browser, so that it can be determined whether a feature may be identified for presentation to the user device 206. For example, the ZSS metadata server 203 may determine based on content metadata that the content is related to political, adult, or otherwise other topics such that no feature of the application is to be presented to the user. Otherwise, the ZSS metadata server 203 may determine that the content is not related to such topics and a feature of the application may be identified for presentation to the user device 206.

The context model server 207 is a back-end component within a system architecture responsible for generating dynamic, context-aware suggestions for a client application, such as a web browser. As part of a feature for providing contextual cues or zero-state suggestions (ZSS), the server receives a request from ZSS metadata server 203 that includes page context data, such as the URL, title, and content of the web page a user is currently viewing. It processes this information, often by formulating a prompt that is sent to a large language model (LLM) or another AI model, to generate a list of relevant suggestions, such as sample questions about the page content. The context model server then returns these generated suggestions to the client system to be displayed to the user, thereby enhancing the application by proactively offering relevant actions or queries. Put another way, the context model server 207 is configured to identify a feature of an application that is to be presented to the user device 206.

In some examples, a web page of an Internet browser is provided as web page server 205 associated with a domain name. An example web site is a collection of web pages formatted in an appropriate machine-readable language, e.g., a markup language such as hypertext markup language (HTML), that can contain text, images, multimedia content, and programming elements, e.g., scripts. The text, images, multimedia content, and programming elements are examples of web page elements. Each web site is maintained by a publisher, e.g., an entity that manages and/or owns the web site. Web page server 205 can be static or dynamic.

In some examples, web page server 205 provides data over the network 202 and is associated with a resource address, e.g., a URL. In some examples, web page server 205 can provide a web site, which includes digital content, such as web pages, word processing documents, and PDF documents, images, video, and feed sources, among other appropriate digital content. The web page server 205 can store content, e.g., words, phrases, images and sounds and may include embedded information, e.g., meta information and hyperlinks, and/or embedded instructions, e.g., scripts.

In some examples, the user device 206 is an electronic device that is under control of a user and is capable of requesting and receiving resources from the web page server 205 over the network 202. Example user devices 206 include personal computers, mobile computing devices, e.g., smartphones, wearable devices, smart televisions, and/or tablet computing devices that can send and receive data over the network 202. The term mobile computing device (“mobile device”) refers to a user device that is configured to communicate over a mobile communications network. A smartphone, e.g., a phone that is enabled to communicate over the Internet, is an example of a mobile device, as are wearables and other smart devices such as smart speakers. A user device 206 typically includes a user application, e.g., an Internet browser, to facilitate the sending and receiving of data over the network 202.

As shown in FIG. 2, the user device 206 includes processor 220. The processor 220 is configured to run the Internet browser and display browser windows within a presentation of the web page in a display of the user device 206. The processor may further be configured to select a browser feature 222 from a list of features for “nudging” the user toward use of the feature by associating the feature with a UI element.

As shown in FIG. 1B, the user device 206, via processor 220, provides a user interface (UI) 211 of a browser. In the example of FIG. 1B, the UI 211 is shown in a single browser tab displaying a web page. Also shown in FIG. 2 is the UI 211 as a separate entity from the processor 220. While this is one possible configuration, in some implementations shown in FIG. 2, elements of the UI 211 are integrated into the processor 220.

As shown in FIG. 2, the UI 211 includes a UI element for surfacing a browser feature 212. The UI element is associated with a feature 222 of the browser. As discussed above, the feature 222 is selected by the browser via processor 220. In some implementations, the selection of the feature 222 is performed according to a ranking of an available set of features. In such an implementation, the selected feature 222 would be one of the top-ranked or the top-ranked feature. The ranking, in some implementations, is based on the relevance of a feature of the list of features to content of the web page. In some implementations, the ranking is also based on the relevance of the feature of a list of features to a user history.

Further to the descriptions above, a user may be provided with controls allowing the user to make an election as to both if and when systems, applications, or features described herein may enable collection of user information (e.g., information about a user history, a user's preferences, or a user's current location), and if the user is sent content or communications from a server. In addition, certain data may be treated in one or more ways before it is stored or used, so that personally identifiable information is removed. For example, a user history may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user. Additionally, the user may be presented with an option to disable a feature. In some implementations, there is an upper limit to a number of times the user is shown the application.

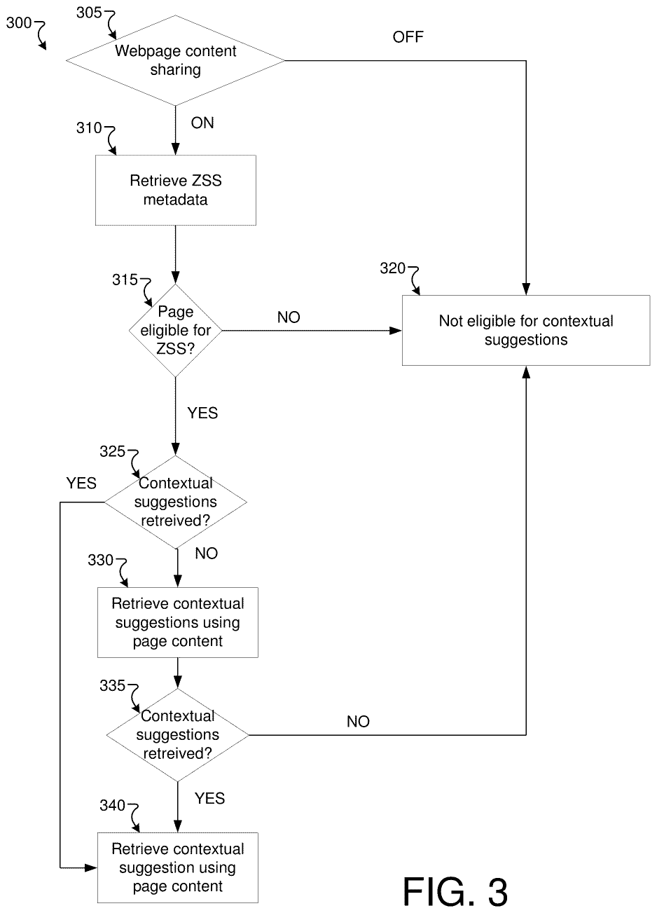

FIG. 3 is a flow chart illustrating an example process 300 of identifying a feature of the application for display in a user interface.

At 305, the process includes determining whether webpage content sharing is activated. If not, e.g., “OFF,” then the webpage content at 320 is not eligible for contextual suggestions. Put another way, no feature of the application is eligible for display to the user via an element of the user interface associated with the feature. Nevertheless, if webpage content sharing is “ON,” then the process 300 advances to 310 via a signal from a user device on which the application runs to a zero state suggestion metadata server.

At 310, zero state suggestion (ZSS) metadata is retrieved from, e.g., a ZSS metadata server (e.g., ZSS metadata server 203 in FIG. 2). The ZSS metadata server receives a request from the user device, such as a page navigation or user hover event. In response, the ZSS metadata server provides a classification that can take the form of an eligibility flag or, for some static pages, a list of pre-computed contextual suggestions. If pre-computed suggestions are unavailable but the page is deemed eligible, the ZSS metadata server coordinates with other backend systems, such as a context model server, to generate dynamic suggestions based on the page's content before returning the final suggestions to the client.

In some implementations, the ZSS metadata is retrieved based on a user privacy setting in the case of a browser. For example, when an enhanced privacy setting is enabled, ZSS metadata is retrieved proactively upon page navigation. If such a setting is not enabled, then the ZSS metadata is retrieved on demand upon a hover event.

At 315, it is determined based on the ZSS metadata whether the content of the webpage is eligible for a ZSS, e.g., an indication of a feature of the application to be displayed on the user device. In some cases, the content is not eligible (“NO”) and no ZSS is provided, or a null ZSS is provided. For example, it may have been determined that the webpage was directed to adult content, political content, or the content is hidden behind a paywall; in such cases, no ZSS may be provided. The classifications by which no ZSS is provided may be determined using a specified criterion. In some cases, however, when the ZSS metadata indicates that the classification of the content is not one by which a ZSS is not provided, the process 300 advances to 325. In some implementations, there are pre-computed suggestions embedded in the ZSS metadata.

At 325, it is determined whether any contextual suggestions, e.g., ZSS, have been retrieved from the ZSS metadata server. As stated above, such suggestions may take the form of pre-computed contextual suggestions. In this case, the process advances to 340, where a contextual suggestion is retrieved using webpage content and the identified feature is displayed via an element of the user interface associated with the feature. If, however, no contextual suggestions have been retrieved from the ZSS metadata server, then such suggestions would be generated by a context model server (e.g., context model server 207 in FIG. 2), and the process advances to 330.

At 330, the ZSS metadata server sends a request to the context model server to generate contextual suggestions, e.g., an identifier of a feature to be displayed on the display of the user device.

At 335, it is determined whether a contextual suggestion has been retrieved from the context model server. For example, despite the content being eligible for a ZSS, there may be situations in which the context model that runs on the context model server is unable to determine a contextual suggestion (“NO”). In such a case, the content is not eligible for contextual suggestions. If, however, the model returns at least one contextual suggestion, then contextual suggestions are retrieved from the context model server and the process advances to 340 where the contextual suggestions are retrieved and used to identify a feature (e.g., via ranking) for display on the user device.

In some implementations, when the application is a browser, there may be variations in the presentation of the user interface based on the user's browsing history. For example, in a first run experience (FRE) for a new user, only a single suggestion may be provided. In other cases, however, more than one suggestion may be provided.

In some implementations, when the application is a browser, generated suggestions may be cached to improve performance when a user switches back to a tab. The suggestions may be erased from the cache when the user navigates to a new page.

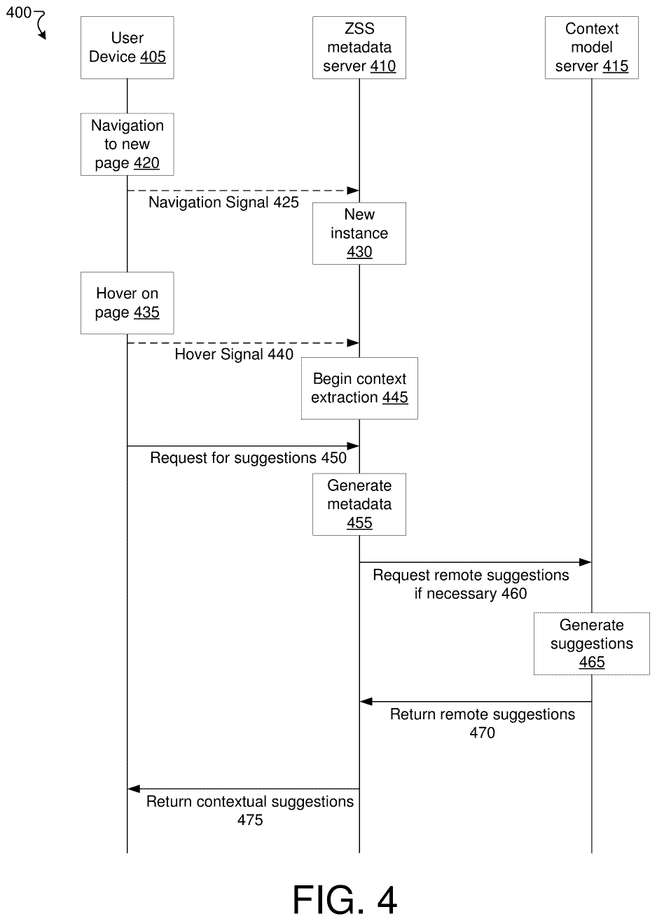

FIG. 4 is a sequence diagram illustrating an example process 400 of identifying a feature of the application for display in a user interface. The process 400 involves a user device 405, a ZSS metadata server 410, and a context model server 415. The process 400 as illustrated in FIG. 4 pertains to the case of the application being a browser but this example should not be seen as limiting and any application will follow a similar process.

The process 400 begins at the user device 405, in which at 420 a user navigates the browser to a new webpage. In response, the user device 405 generates and sends a navigation signal 425 to the ZSS metadata server 410. In some implementations, the navigation signal 425 takes the form of a URL of the webpage. In response to receiving the navigation signal 425, the ZSS metadata server 410 generates a new instance 430 that reserves computational resources for the determination of ZSS eligibility.

After the user navigates to the new webpage, at 435 the user may choose to hover over a specified location in the webpage. For example, the user may place a cursor or marker over a button or other selectable control in the webpage without clicking on the button or control; this is a hover event. In response to the hover event, the user device 405 generates and sends a hover signal 440. The hover signal 440, in some implementations, takes the form of a request that includes URL information for the webpage. The hover signal 440 proactively preconnects to the remote context model server 415 to reduce network latency when a full request is made. In response to receiving the hover signal 440, the ZSS metadata server 410 begins a context extraction 445 in which the URL information for the webpage is analyzed and contexts identified.

After the user device 405 sends the hover signal 440 to the ZSS metadata server 410, the user device 405 generates and sends a request for suggestions 450 to the ZSS metadata server 410. The ZSS metadata server 410 generates webpage metadata 455 in response to the request for suggestions 450. In some implementations, the ZSS metadata server 410 relays the request for suggestions 450 and the URL information to an external server that generates the metadata 455.

In some cases, the ZSS metadata server 410 generates the contextual suggestions. Nevertheless, if this is not the case, then after the metadata 455 is generated, the ZSS metadata server 410 sends a request 460 for remote suggestions to the context model server 415. Iin response to receiving the request 460, the context model server 415 generates contextual suggestions 465 and at 470, and returns the contextual suggestions 475 to the ZSS metadata server 410. The ZSS metadata server 410, in turn, returns the contextual suggestions 465 to the user device 405.

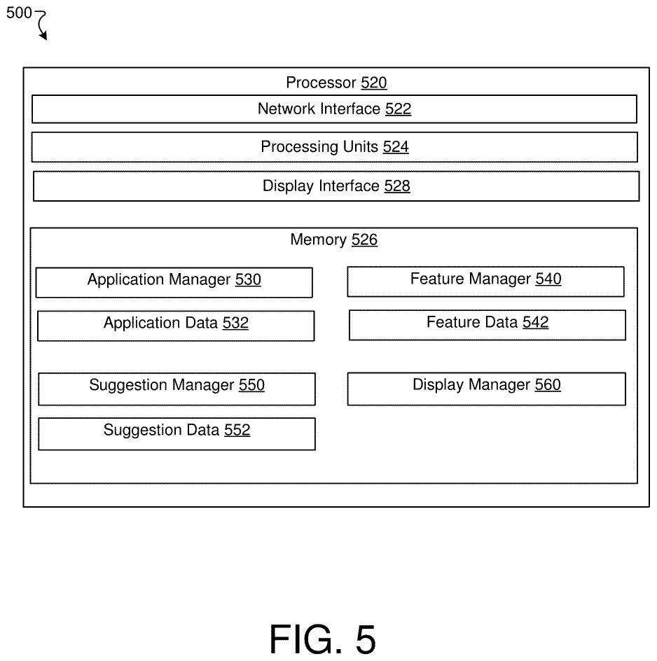

FIG. 5 is a diagram illustrating an example electronic environment 500 in which the identification of the feature may be implemented. As shown in FIG. 5, the electronic environment 500 includes a processor 520 which is identical in function to the processor 220 of FIG. 2.

The processor 520 includes a network interface 522, one or more processing units 524, and the (nontransitory) memory 526. The network interface 522 includes, for example, Ethernet adaptors, Bluetooth adaptors, and the like, for converting electronic and/or optical signals received from the network to electronic form for use by the processor 520. The set of processing units 524 include one or more processing chips and/or assemblies. The memory 526 is a storage medium and includes both volatile memory (e.g., RAM) and non-volatile memory, such as one or more read only memories (ROMs), disk drives, solid state drives, and the like. The set of processing units 524 and the memory 526 together form part of the processor 520, which is configured to perform various methods and functions as described herein as a computer program product. The display interface 528 includes adaptors for sending a video signal to a display.

In some implementations, one or more of the components of the processor 520 can be, or can include processors (e.g., processing units 524) configured to process instructions stored in the memory 526. Examples of such instructions as depicted in FIG. 5 include an application manager 530, a feature manager 540, a suggestion manager 550, and a display manager 560. Further, as illustrated in FIG. 5, the memory 526 is configured to store various data, which is described with respect to the respective managers that use such data.

The application manager 530 is configured to run an application on a user device and hence generate application data 532. For example, the application can take the form of an Internet browser. In that case, the application data 532 can take the form of a browsing history. The application data 532 may also include elements of a user interface that are associated with features of the application.

The feature manager 540 is configured to determine, as feature data 542, a list of features of the application that may be eligible for contextual suggestions. For example, in the case of an Internet browser, a feature of the application may be related to a security function, e.g., a function that provides protection from dangerous websites, or a tab function, e.g., a function that provides a tab hover preview card. The feature data 542 may also include pointers to elements of the user interface associated with the features.

The suggestion manager 550 is configured to determine contextual suggestions for displaying certain lesser-known features to the user. As discussed above, the suggestion manager 550 is configured to send a request to a ZSS metadata server that is configured to determine whether the application is eligible for a contextual suggestion and, in some cases, return, as suggestion data 552, contextual suggestions. In some implementations, the ZSS metadata server is configured to send ZSS metadata to a context model server which in turn generates suggestions.

The display manager 560 is configured to display an element of a user interface of the application associated with the feature identified in the suggestion data 552.

The components (e.g., modules, processing units 524) of processor 520 can be configured to operate based on one or more platforms (e.g., one or more similar or different platforms) that can include one or more types of hardware, software, firmware, operating systems, runtime libraries, and/or so forth. In some implementations, the components of the processor 520 can be configured to operate within a cluster of devices (e.g., a server farm). In such an implementation, the functionality and processing of the components of the processor 520 can be distributed to several devices of the cluster of devices.

The components of the processor 520 can be, or can include, any type of hardware and/or software configured to process attributes. In some implementations, one or more portions of the components shown in the components of the processor 220 in FIG. 2 can be, or can include, a hardware-based module (e.g., a digital signal processor (DSP), a field programmable gate array (FPGA), a memory), a firmware module, and/or a software-based module (e.g., a module of computer code, a set of computer-readable instructions that can be executed at a computer). For example, in some implementations, one or more portions of the components of the processor 520 can be, or can include, a software module configured for execution by at least one processor (not shown). In some implementations, the functionality of the components can be included in different modules and/or different components than those shown in FIG. 5, including combining functionality illustrated as two components into a single component.

Although not shown, in some implementations, the components of the processor 520 (or portions thereof) can be configured to operate within, for example, a data center (e.g., a cloud computing environment), a computer system, one or more server/host devices, and/or so forth. In some implementations, the components of the processor 520 (or portions thereof) can be configured to operate within a network. Thus, the components of the processor 520 (or portions thereof) can be configured to function within various types of network environments that can include one or more devices and/or one or more server devices. For example, the network can be, or can include, a local area network (LAN), a wide area network (WAN), and/or so forth. The network can be, or can include, a wireless network and/or wireless network implemented using, for example, gateway devices, bridges, switches, and/or so forth. The network can include one or more segments and/or can have portions based on various protocols such as Internet Protocol (IP) and/or a proprietary protocol. The network can include at least a portion of the Internet.

In some implementations, one or more of the components of the search system can be, or can include, processors configured to process instructions stored in a memory. For example, application manager 530 (and/or a portion thereof), feature manager 540 (and/or a portion thereof), suggestion manager 550 (and/or a portion thereof), and display manager 560 (and/or a portion thereof) are examples of such instructions.

In some implementations, the memory 526 can be any type of memory such as a random-access memory, a disk drive memory, flash memory, and/or so forth. In some implementations, the memory 526 can be implemented as more than one memory component (e.g., more than one RAM component or disk drive memory) associated with the components of the processor 520. In some implementations, the memory 526 can be a database memory. In some implementations, the memory 526 can be, or can include, a non-local memory. For example, the memory 526 can be, or can include, a memory shared by multiple devices (not shown). In some implementations, the memory 526 can be associated with a server device (not shown) within a network and configured to serve the components of the processor 520. As illustrated in FIG. 5, the memory 526 is configured to store various data, including feature data 542 and suggestion data 552.

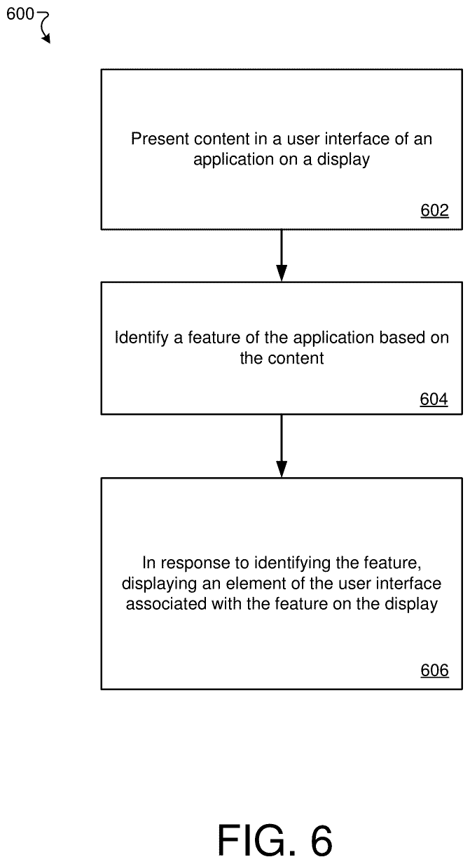

FIG. 6 is a flow chart illustrating an example method 600 of identifying a feature of the application for display in a user interface. The method 600 may be performed with a processor, e.g., processor 220 in FIG. 2.

At 602, an application manager (e.g., application manager 530) presents content in a user interface of an application on a display.

At 604, a feature manager (e.g., feature manager 540) and a suggestion manager (e.g., suggestion manager 550) identify a feature of the application based on the content.

At 606, a display manager (e.g., display manager 560), in response to identifying the feature, displays an element of the user interface associated with the feature on the display.

Example 1. A computer program product comprising a nontransitory storage medium, the computer program product including code that, when executed by a processor, causes the processor to perform a method, the method comprising: presenting content in a user interface of an application that interacts with an input device; detecting an interaction between the input device and the user interface; in response to the interaction, initiating a connection with a computer configured to identify a feature of the application based on the content; receiving, from the computer, the feature being identified; and in response to receiving the feature, presenting an element of the user interface associated with the feature.

Example 2. The computer program product as in Example 1, wherein the application includes a browser configured to access a resource and the user interface includes a browser window; and wherein receiving the feature includes: receiving a set of features of the browser, the set of features being identified based on the content, the content being associated with the resource; ranking features of the set of features according to respective relevance scores of the features to the content; and selecting, as the feature, a top-ranked feature of the set of features.

Example 3. The computer program product as in Example 2, wherein the method further comprises: ranking the features of the set of features according to a relevance of the set of features to the content and to a user history.

Example 4. The computer program product as in Example 2, wherein receiving the set of features includes: comparing a resource locator of the resource to a set of predefined resource locators to produce a comparison, the set of predefined resource locators being associated with at least one feature of the set of features; and identifying the set of features based on the comparison.

Example 5. The computer program product as in Example 2, wherein the method further comprises: in response to receiving the set of features, generating a relationship between the content associated with the resource to the set of features.

Example 6. The computer program product as in Example 2, wherein ranking the features includes: inputting the content and a user history into a model configured to output the ranking of the features.

Example 7. The computer program product as in Example 1, wherein the computer is a first computer; and wherein receiving the feature includes: sending a request to a second computer configured to classify the content into a classification; and in response to the request: receiving the identified feature in response to determining that the classification is a first classification; and receiving an indication that no feature is to be suggested in response to determining that the classification is a second classification.

Example 8. The computer program product as in Example 1, wherein the feature is identified in response to detecting a hover event on a portion of the user interface.

Example 9. The computer program product as in Example 1, wherein receiving the feature includes: sending a request to a server to create an identifier for the feature ; in response to the request, receiving the identifier from the server; and using the identifier to select the feature.

Example 10. A method, comprising: presenting content in a user interface of an application that interacts with an input device; detecting an interaction between the input device and the user interface; in response to the interaction, initiating a connection with a computer configured to identify a feature of the application based on the content; receiving, from the computer, the feature being identified; and in response to receiving the feature, presenting an element of the user interface associated with the feature.

Example 11. The method as in Example 10, wherein the application includes a browser configured to access a resource and the user interface includes a browser window; and wherein receiving the feature includes: receiving a set of features of the browser, the set of features being identified based on the content, the content being associated with the resource; ranking features of the set of features according to respective relevance scores of the features to the content; and selecting, as the feature, a top-ranked feature of the set of features.

Example 12. The method as in Example 11, further comprising: ranking the features of the set of features according to a relevance of the set of features to the content and to a user history.

Example 13. The method as in Example 11, wherein receiving the set of features includes: comparing a resource locator of the resource to a set of predefined resource locators to produce a comparison, the set of predefined resource locators being associated with at least one feature of the set of features; and identifying the set of features based on the comparison.

Example 14. The method as in Example 11, further comprising: in response to receiving the set of features, generating a relationship between the content associated with the resource to the set of features.

Example 15. The method as in Example 11, wherein ranking the features includes: inputting the content and a user history into a prediction engine configured to output ranks for the features.

Example 16. The method as in Example 10, wherein receiving the feature includes: sending a request to a computer configured to classify the content into a classification; and in response to the request: receiving the identified feature in response to determining that the classification is a first classification; and receiving an indication that no feature is to be suggested in response to determining that the classification is a second classification.

Example 17. The method as in Example 10, wherein the feature is identified in response to detecting a hover event on a portion of the user interface.

Example 18. The method as in Example 10, wherein identifying the feature includes: sending a request to a server configured to create an identifier for the feature; in response to the request, receiving the identifier from the server; and using the identifier to select the feature.

Example 19. A computing system comprising: memory; and a processor coupled to the memory, the processor being configured to: present content in a user interface of an application that interacts with an input device; detect an interaction between the input device and the user interface; in response to the interaction, initiate a connection with a computer configured to identify a feature of the application based on the content; receive, from the computer, the feature being identified; and in response to receive the feature, presenting an element of the user interface associated with the feature.

Example 20. A computing system as in Example 19, wherein the application includes a browser configured to access a resource and the user interface includes a browser window; and wherein the processor configured to receive the feature is further configured to: receive a set of features of the browser, the set of features being identified based on the content, the content being associated with the resource; rank features of the set of features according to respective relevance scores of the features to the content; and select, as the feature, a top-ranked feature of the set of features.

Example 21. The computing system as in Example 20, further comprising: ranking the features of the set of features according to a relevance of the set of features to the content and to a user history.

Example 22. The computing system as in Example 20, wherein receiving the set of features includes: comparing a resource locator of the resource to a set of predefined resource locators to produce a comparison, the set of predefined resource locators being associated with at least one feature of the set of features; and identifying the set of features based on the comparison.

Example 23. The computing system as in Example 20, further comprising: in response to receiving the set of features, generating a relationship between the content associated with the resource to the set of features.

Example 24. The computing system as in Example 20, wherein ranking the features includes: inputting the content and a user history into a prediction engine configured to output ranks for the features.

Example 25. The computing system as in Example 19, wherein receiving the feature includes: sending a request to a computer configured to classify the content into a classification; and in response to the request: receiving the identified feature in response to determining that the classification is a first classification; and receiving an indication that no feature is to be suggested in response to determining that the classification is a second classification.

Example 26. The computing system as in Example 19, wherein the feature is identified in response to detecting a hover event on a portion of the user interface.

Example 27. The computing system as in Example 19, wherein identifying the feature includes: sending a request to a server configured to create an identifier for the feature; in response to the request, receiving the identifier from the server; and using the identifier to select the feature.

Example implementations can include a non-transitory computer-readable storage medium comprising instructions stored thereon that, when executed by at least one processor, are configured to cause a computing system to perform any of the methods described above. Example implementations can include an apparatus including means for performing any of the methods described above. Example implementations can include an apparatus including at least one processor and at least one memory including computer program code, the at least one memory and the computer program code configured to, with the at least one processor, cause the apparatus at least to perform any of the methods described above.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (a LED (light-emitting diode), or OLED (organic LED), or LCD (liquid crystal display) monitor/screen) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of implementations have been described. Nevertheless, it will be understood that various modifications may be made without departing from the spirit and scope of the specification.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

While example implementations may include various modifications and alternative forms, implementations thereof are shown by way of example in the drawings and will herein be described in detail. It should be understood, however, that there is no intent to limit example implementations to the particular forms disclosed, but on the contrary, example implementations are to cover all modifications, equivalents, and alternatives falling within the scope of the claims. Like numbers refer to like elements throughout the description of the figures.

Some of the above example implementations are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Methods discussed above, some of which are illustrated by the flow charts, may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a storage medium. A processor(s) may perform the necessary tasks.

Specific structural and functional details disclosed herein are merely representative for purposes of describing example implementations. Example implementations, however, be embodied in many alternate forms and should not be construed as limited to only the implementations set forth herein.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element, without departing from the scope of example implementations. As used herein, the term and/or includes any and all combinations of one or more of the associated listed items.

It will be understood that when an element is referred to as being connected or coupled to another element, it can be directly connected or coupled to the other element or intervening elements may be present. In contrast, when an element is referred to as being directly connected or directly coupled to another element, there are no intervening elements present. Other words used to describe the relationship between elements should be interpreted in a like fashion (e.g., between versus directly between, adjacent versus directly adjacent, etc.).

The terminology used herein is for the purpose of describing particular implementations only and is not intended to be limiting of example implementations. As used herein, the singular forms a, an and the are intended to include the plural forms as well, unless the context clearly indicates otherwise. It will be further understood that the terms comprises, comprising, includes and/or including, when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may in fact be executed concurrently or may sometimes be executed in the reverse order, depending upon the functionality/acts involved.

Unless otherwise defined, all terms (including technical and scientific terms) used herein have the same meaning as commonly understood by one of ordinary skill in the art to which example implementations belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the above example implementations and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the above illustrative implementations, reference to acts and symbolic representations of operations (e.g., in the form of flowcharts) that may be implemented as program modules or functional processes include routines, programs, objects, components, data structures, etc., that perform particular tasks or implement particular abstract data types and may be described and/or implemented using existing hardware at existing structural elements. Such existing hardware may include one or more Central Processing Units (CPUs), digital signal processors (DSPs), application-specific-integrated-circuits, field programmable gate arrays (FPGAs) computers or the like.

It should be borne in mind, however, that all of these and similar terms are to be associated with the appropriate physical quantities and are merely convenient labels applied to these quantities. Unless specifically stated otherwise, or as is apparent from the discussion, terms such as processing or computing or calculating or determining of displaying or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the example implementations are typically encoded on some form of non-transitory program storage medium or implemented over some type of transmission medium. The program storage medium may be magnetic (e.g., a floppy disk or a hard drive) or optical (e.g., a compact disk read only memory, or CD ROM), and may be read only or random access. Similarly, the transmission medium may be twisted wire pairs, coaxial cable, optical fiber, or some other suitable transmission medium known to the art. The example implementations are not limited by these aspects of any given implementation.

Lastly, it should also be noted that whilst the accompanying claims set out particular combinations of features described herein, the scope of the present disclosure is not limited to the particular combinations hereafter claimed, but instead extends to encompass any combination of features or implementations herein disclosed irrespective of whether or not that particular combination has been specifically enumerated in the accompanying claims at this time.

What is claimed is:

1. A computer program product comprising a nontransitory storage medium, the computer program product including code that, when executed by a processor, causes the processor to perform a method, the method comprising:
presenting content in a user interface of an application that interacts with an input device;
detecting an interaction between the input device and the user interface;
in response to the interaction, initiating a connection with a computer configured to identify a feature of the application based on the content;
receiving, from the computer, the feature being identified; and
in response to receiving the feature, presenting an element of the user interface associated with the feature.

2. The computer program product as in claim 1, wherein the application includes a browser configured to access a resource and the user interface includes a browser window; and
wherein receiving the feature includes:
receiving a set of features of the browser, the set of features being identified based on the content, the content being associated with the resource;
ranking features of the set of features according to respective relevance scores of the features to the content; and
selecting, as the feature, a top-ranked feature of the set of features.

3. The computer program product as in claim 2, wherein the method further comprises:
ranking the features of the set of features according to a relevance of the set of features to the content and to a user history.

4. The computer program product as in claim 2, wherein receiving the set of features includes:
comparing a resource locator of the resource to a set of predefined resource locators to produce a comparison, the set of predefined resource locators being associated with at least one feature of the set of features; and
identifying the set of features based on the comparison.

5. The computer program product as in claim 2, wherein the method further comprises:
in response to receiving the set of features, generating a relationship between the content associated with the resource to the set of features.

6. The computer program product as in claim 2, wherein ranking the features includes:
inputting the content and a user history into a model configured to output the ranking of the features.

7. The computer program product as in claim 1, wherein the computer is a first computer; and
wherein receiving the feature includes:
sending a request to a second computer configured to classify the content into a classification; and
in response to the request:
receiving the identified feature in response to determining that the classification is a first classification; and
receiving an indication that no feature is to be suggested in response to determining that the classification is a second classification.

8. The computer program product as in claim 1, wherein the feature is identified in response to detecting a hover event on a portion of the user interface.

9. The computer program product as in claim 1, wherein receiving the feature includes:
sending a request to a server to create an identifier for the feature;
in response to the request, receiving the identifier from the server; and
using the identifier to select the feature.

10. A method, comprising:
presenting content in a user interface of an application that interacts with an input device;
detecting an interaction between the input device and the user interface;
in response to the interaction, initiating a connection with a computer configured to identify a feature of the application based on the content;
receiving, from the computer, the feature being identified; and
in response to receiving the feature, presenting an element of the user interface associated with the feature.

11. The method as in claim 10, wherein the application includes a browser configured to access a resource and the user interface includes a browser window; and
wherein receiving the feature includes:
receiving a set of features of the browser, the set of features being identified based on the content, the content being associated with the resource;
ranking features of the set of features according to respective relevance scores of the features to the content; and
selecting, as the feature, a top-ranked feature of the set of features.

12. The method as in claim 11, further comprising:
ranking the features of the set of features according to a relevance of the set of features to the content and to a user history.

13. The method as in claim 11, wherein receiving the set of features includes:
comparing a resource locator of the resource to a set of predefined resource locators to produce a comparison, the set of predefined resource locators being associated with at least one feature of the set of features; and
identifying the set of features based on the comparison.

14. The method as in claim 11, further comprising:
in response to receiving the set of features, generating a relationship between the content associated with the resource to the set of features.

15. The method as in claim 11, wherein ranking the features includes:
inputting the content and a user history into a prediction engine configured to output ranks for the features.

16. The method as in claim 10, wherein receiving the feature includes:
sending a request to a computer configured to classify the content into a classification; and
in response to the request:
receiving the identified feature in response to determining that the classification is a first classification; and
receiving an indication that no feature is to be suggested in response to determining that the classification is a second classification.

17. The method as in claim 10, wherein the feature is identified in response to detecting a hover event on a portion of the user interface.

18. The method as in claim 10, wherein identifying the feature includes:
sending a request to a server configured to create an identifier for the feature;
in response to the request, receiving the identifier from the server; and
using the identifier to select the feature.

19. A computing system comprising:
memory; and
a processor coupled to the memory, the processor being configured to:
present content in a user interface of an application that interacts with an input device;
detect an interaction between the input device and the user interface;
in response to the interaction, initiate a connection with a computer configured to identify a feature of the application based on the content;
receive, from the computer, the feature being identified;
and
in response to receive the feature, presenting an element of the user interface associated with the feature.

20. The computing system as in claim 19, wherein the application includes a browser configured to access a resource and the user interface includes a browser window; and
wherein the processor configured to receive the feature is further configured to:
receive a set of features of the browser, the set of features being identified based on the content, the content being associated with the resource;
rank features of the set of features according to respective relevance scores of the features to the content; and
select, as the feature, a top-ranked feature of the set of features.
